(19) United States
(12) Patent Application Publication
(10) Pub. No.: US 2007/0119903 A1
(43) Pub. Date: May 31, 2007

(54) Two-step high bottleneck type capillary for wire bonding device

(76) Inventors: Jung Ku Lee, Seoul (KR); Hyun Bum Sung, Hanam-Shi (KR); Hae Bal Lee, Gwangju (KR); Jung Ju Moon, Gwangju (KR); Kang Yong Lee, Seoul (KR)

Correspondence Address: Peter T. Kwon;G W i P S, P. O. Box 231630, Centreville, VA, 20120, US

(21) Appl. No.: 11/342,188

(22) Filed: Jan. 27, 2006

(30) Foreign Application Priority Data
Nov. 28, 2005 (KR) 2005-114006

(51) Int. Cl. B23K 37/00; B23K 1/06; B23K 5/20

(52) U.S. Cl. 228/4.5; 228/1.1; 228/6.1

(57) ABSTRACT

A two-step high bottleneck type capillary for a wire bonding device having a height of 1.5˜5.0 mm and taper of 10˜15° from the capillary end is disclosed. The capillary consists of a straight portion; a first bottleneck portion extending upwards from the end of the capillary to a first step with a first taper of 8˜12°, said the first bottleneck portion having a first height of 0.1˜0.5 mm from the end of the capillary to the first step; and a second bottleneck portion extending upwards from the first step to a second step on the border of the straight portion with a second taper of 10˜15°, the second bottleneck portion having a second height of 1.1˜5.0 mm from the end of the capillary to the second step.

### BACKGROUND OF THE INVENTION

1. Field of the Invention

The present invention relates to a capillary for use in a wire bonding device which can be effectively applied to bonding processes such as bonding a plurality of pad layers and low-K packages, namely, packages showing low thermal resistance values due to very thin layers of metal oxide, and more specifically to a two-step high bottleneck type capillary for a wire bonding device having a height of 1.5˜5.0 mm and a taper of 10˜15° from the capillary end.

2. Description of the Related Art

Modern electronic equipment is made up of a printed circuit board with integrated circuits mounted on top, and the arts in the public domain for connecting the integrated circuit to the board include wire bonding, automatic bonding of tape, and the flip-chip technique. The most common technique of these is wire bonding.

Capillaries used in a wire bonding device will be described in more detail with reference to FIG. 1. Commonly used capillaries are classified into type A, type B, type C and type D, and the inside has a fine hole of a very small diameter. Therefore, wire bonding work is done while introducing wire through this fine hole.

Referring to FIG. 1, the end of a type A, or normal, capillary is formed with a predetermined taper (for example, 20, 30 or 50°) from the straight portion to the end of the capillary. Type B, type C and type D are formed with a predetermined taper (for example, 20, 30 or 50°) from the straight portion to a step of predetermined taper and a length (for example, a taper of 8˜10° and a height of 0.1˜0.4 mm), and are usually called bottleneck capillaries.

A normal capillary having the end according to type A is used for wire bonding of a package in which the area of the wire bonding portion and the interval of the bonding portion have relatively sufficient clearance. Normally, the one in which the diameter of the end of the capillary is about 0. 15˜0.25 mm and the diameter of the thin alloy wire is about 0.025˜0.038 mm is used.

A bottleneck capillary having the end shape according to type B, type C or type D is used in the case that the area of the wire bonding portion and the interval of the bonding portion is very dense. Recently, as integrated circuits become more densely packaged, bottleneck capillaries are mainly used. In general, the one in which the diameter of the capillary end is 0.05˜0.15 mm and the diameter of the thin alloy wire is about 0.020˜0.025 mm is used.

Recently, due to densely integrated circuits, there is a tendency that the area of the bonding portion is reduced and the interval between adjacent bonding portions becomes very small. Therefore, unless the diameter of the end of the capillary is reduced, contact occurs between adjacent bonding portions in the process of wire bonding, and contact is inevitably created between adjacent wires, so the shape of the end of the capillary is made in a bottleneck to prevent this.

Also, sufficient spacing in the same plane can be accomplished by increasing the interval between wire bonding portions, while integration becomes denser in the direction of height. By reducing the spacing between bonding portions in the direction of height like this, the arrangement of bonding portions is made in a grid form. In such a case, contact is created in the bonded wire in the direction of height, and since the capillary also should be made thin in the direction of height, the height of the bottleneck of the capillary should be increased.

As described above, the area of the bonding portion is reduced to accomplish denser integration, but nevertheless the reliability required for the values of the shear strength and tensile strength of the bonding portion, which are the final results of wire bonding, should be secured sufficiently. Namely, considering that the original technique of wire bonding is ultrasonic thermal compression, the bonding force and ultrasonic power added to the capillary during the wire bonding process should be maintained at optimum conditions as well, and also the structure of the capillary should be manufactured so as to satisfy this condition sufficiently.

With reference to FIG. 3, we will see problems arising during the process in the case of applying capillaries according to the conventional art in wire bonding of, for example, a 3 tier pad layer device. The photograph in FIG. 3 shows the case in which the diameter of the end of the capillary is reduced to allow bonding within the area of the bonding portion, but the shape of the wire that was originally formed is deformed due to contact with adjacent bonded wire by the end of the capillary during the wire bonding process because of insufficient height of bottleneck. If such a problem arose, a process for correcting the shape of the wire is needed.

A conventional art for overcoming such a problem is increasing the height of the bottleneck formed at the end of the capillary to avoid damage to the bonded wire by the capillary.

But primarily due to the structural limit inside the capillary, there arises a problem of the bottleneck being cut during the process of wire bonding if the height of the bottleneck is excessively increased. Also, depending on the various conditions added during the process of wire bonding, the required values of bonding force and ultrasonic power rapidly increase to make wire bonding difficult. Because of that, it becomes impossible to obtain the targeted shape stability of the bonding portion and required values of tensile strength and shear strength due to excessively given bonding force and ultrasonic power despite the progress of wire bonding.

Also, the increase in the values of bonding force and ultrasonic power introduces problems affecting the capillary over its lifetime, etc. that should not be overlooked.

### SUMMARY OF THE INVENTION

Therefore, it is an object of the present invention to provide a two-step high bottleneck type capillary for a wire bonding device comprising a first bottleneck portion having a predetermined height and taper from the end of the capillary and a second bottleneck portion having a height of about 1.5˜5.0 mm and a taper of 10˜15° from the end of the capillary, formed to greatly increase the height of the bottleneck so as to prevent contact and deformation of the wire by the capillary during the wire bonding process of a plurality of pad layer packages, etc.

Another object of the present invention is to provide a two-step high bottleneck type capillary for a wire bonding device in which the conventional capillary in a conical shape is changed to a step type having two steps to add bonding force and allow the use of ultrasonic power lower than those of a conventional capillary during the wire bonding process so that the shape stability and values of tensile strength and shear strength of the bonding portion can be increased by the amplitude increase at the end of the capillary.

In accordance with the present invention, there is provided a two-step high bottleneck type capillary for a wire bonding device comprising: a straight portion; a first bottleneck portion upwardly extended from the end of the capillary to a first step with a first taper of 8˜12°, the first bottleneck portion having a first height of 0.1˜0.5 mm from the end of capillary to the first step; and a second bottleneck portion upwardly extended from the first step to a second step on the border of the straight portion with a second taper of 10˜15°, the second bottleneck portion having a second height of 1.1˜5.0 mm from the end of the capillary to the second step.

### BRIEF DESCRIPTION OF THE DRAWINGS

FIG. 1 is an elevation view showing a conventional capillary.

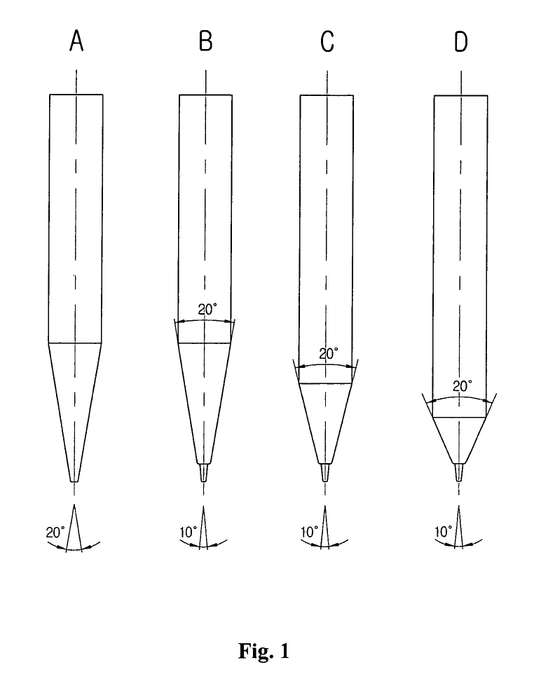

FIG. 2 is a schematic view showing a wire bonding process using a conventional capillary.

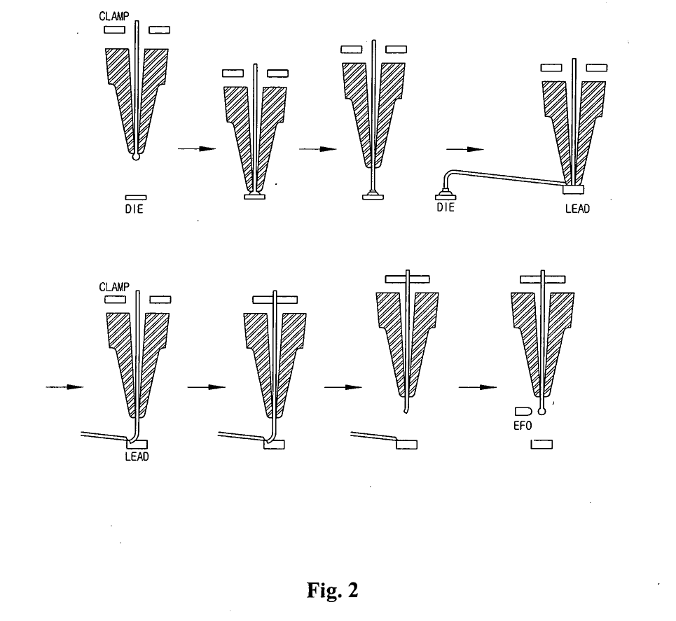

FIG. 3 is a photograph showing problems arising from wire bonding using a conventional capillary.

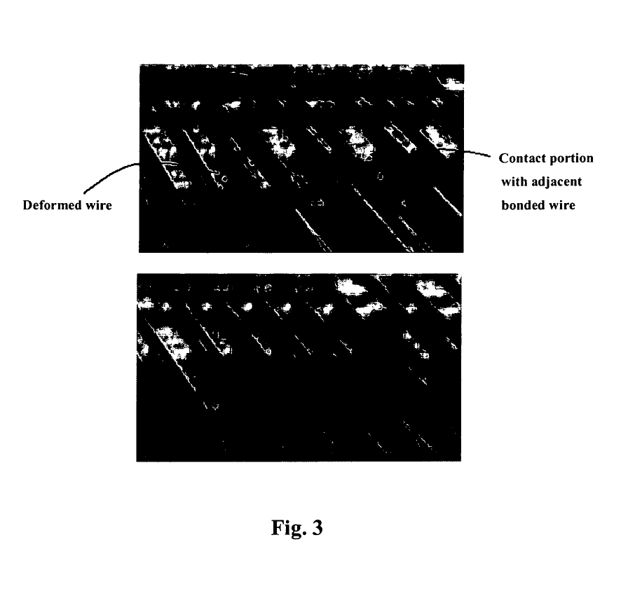

FIG. 4 is an elevation view showing a capillary according to a preferred embodiment of the present invention.

### DETAILED DESCRIPTION OF THE PREFERRED EMBODIMENT

Below will be described a preferred embodiment of the present invention with reference to the accompanying drawings.

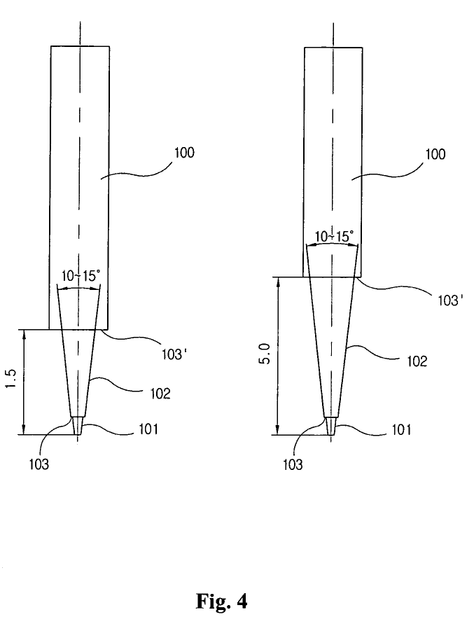

FIG. 4 is an elevation view showing a capillary according to a preferred embodiment of the present invention.

A wire bonding capillary of the present invention comprises a straight portion 100, a first bottleneck portion 101, and a second bottleneck portion 102 formed between the straight portion 100 and the first bottleneck portion 101.

Namely, the end portion of a two-step high bottleneck type capillary for a wire bonding device consists of the first bottleneck portion 101, extending upwards from the end of the capillary to a first step 103 with a first taper of 8˜12°; and a second bottleneck portion 102 extending upwards from the first step 103 to a second step 103′ on the border of the straight portion 100 with a second taper of 10˜15°.

Here, the first bottleneck portion 101 has a first height of 0.1˜0.5 mm from the end of capillary to the first step 103, and the second bottleneck portion 102 has a second height of 1.1˜5.0 mm from the end of the capillary to the second step 103′.

The present inventor has discovered the fact that the ultrasonic horn has basically 4 types of shape: step type, catenoidal type, exponential type and conical type, listed here in decreasing order of enlargement ratio of amplitude according to the shape of the horn. Based on this fact, the end portion of the capillary according to the present invention is formed so as to have a height of 1.5˜5.0 mm and a taper of 12˜15° from the end of the capillary. Therefore, it is possible to provide a capillary having a two-step high bottleneck in addition to a conventional single bottleneck.

This has an advantage of greatly increasing the height of the bottleneck of a conventional capillary and doubles the ability of ultrasonic wave transmission by changing the shape of the end of the finished capillary into a step type.

Therefore, it has fundamentally removed the problem of damaging the loop of an already finished wire by contact between the bonded wire and the capillary during the wire bonding process of a plurality of pad layer packages and has solved the problem of the conventional art by providing an effect of greatly increasing the height of the bottleneck without changing the height of the bottleneck of the capillary end. Thus, it is possible to provide a capillary that can carry out wire bonding while decreasing the values of wire bonding force and ultrasonic power compared with the conventional design.

Again with reference to FIG. 4, the capillary of the present invention having a second bottleneck of a predetermined height, for example 1.5˜5.0 mm from the end of the capillary, is a step type of ultrasonic horn, so the ratio of amplitude of the input end and output end is in proportion to the square of the diameter of both ends, and this is considerably greater compared to the ultrasonic horn of an exponential, catenoidal or conical type.

Therefore, compared with a conventional capillary of a conical type having the taper extended from the end of the capillary to the straight portion at 20, 30 or 50°, the capillary of the present invention has the second bottleneck portion in a step form, so there is a significant difference in the amplitude ratio.

Also, the present inventor has discovered the fact that if the length of the bottleneck portion is excessively increased to avoid contact between capillary and wire in a conventional capillary, wire bonding cannot be carried out smoothly because disagreement is induced to the transducer of the wire bonder performing the function of transmitting ultrasonic waves to the capillary and the resonance characteristic of the capillary, making the necessary bonding force and ultrasonic power increase rapidly. Based on this fact, in order to solve the problem of contact between capillary and wire without changing the length of the bottleneck portion of the end of a conventional capillary, the capillary which has the second bottleneck portion having a height of, for example 1.5˜5.0 mm from the end of the capillary and a taper of, for example 10˜15°, was fabricated.

The capillary of the present invention will be described in more detail based on the examples below; however, the present invention is not limited to these examples.

### EXAMPLE 1

A first bottleneck portion 101 having a height of 0.3 mm from the end of capillary to the first step 103 and a taper of 10° is formed and a second bottleneck portion 102 extending upward from the first bottleneck portion 101 is formed such that the second bottleneck portion 102 has a height of 4.5 mm from the end of the capillary to the second step 103′ and a taper of 15°. At this time, the diameter of the end of the capillary was 0.063 mm and the diameter of the wire guide hole passing through the capillary was 0.028 mm. The capillary fabricated like this was mounted on the wire bonder to carry out the wire bonding.

### EXAMPLE 2

After fabricating a capillary in the same shape as example 1, above, except forming it into a second bottleneck portion 102 having a height of 2.5 mm from the end of the capillary to the second step 103′ and a taper of 15°, it was mounted on the wire bonder to carry out wire bonding.

### EXAMPLE 3

After fabricating a capillary in the same shape as example 1, above, except forming it into a second bottleneck portion 102 having a height of 4.5 mm from the end of the capillary to the second step 103′ and a taper of 12°, it was mounted on the wire bonder to carry out wire bonding.

### EXAMPLE 4

After fabricating a capillary in the same shape as example 1, above, except forming it into a second bottleneck portion 102 having a height of 2.5 mm from the end of the capillary to the second step 103′ and a taper of 12°, it was mounted on the wire bonder to carry out wire bonding.

### COMPARATIVE EXAMPLE

After forming a bottleneck having a height of 0.15 mm from the end of the capillary and a taper of 10° and fabricating a capillary (conventional capillary) having a taper of 50° extending upwards from this bottleneck, it was mounted on the wire bonder to carry out wire bonding.

### COMPARATIVE EXAMPLE 2

After forming a bottleneck having a height of 0.3 mm from the end of the capillary and a 10° taper and fabricating a capillary having a 50° taper extending upwards from this bottleneck, it was mounted on the wire bonder to carry out the wire bonding process. The reason why the bottleneck was formed at the height of 0.3 mm from the end of the capillary is that the height was increased to solve the problem of contact with adjacent wire during the wire bonding process by the capillary as described above. Referring to Examples 1 through 4 and Comparative Examples 1 and 2, the results of carrying out wire bonding on a 3-tier pad layer package are shown in Table 1.

TABLE 1
Results of carrying out wire bonding on a 3-tier pad layer package

| | Class | | | | | | |
|---|---|---|---|---|---|---|---|
| | Bonding Parameters | | | | | | |
| | Time | Power | Force | Ball Shear | Pull Test | | Capillary |
| Results | (10 ± 5) | (75 ± 20) | (11 ± 5) | (grf) | (grf) | Wire Contact | Lifetime |
| Comparative | 10 | 75 | 11 | AVG13.22 | AVG7.85 | 100% | AVG800k |
| Example 1 | | | | | | | |
| Comparative | 15 | 118 | 15 | AVG10.35 | AVG6.21 | 0 | AVG400k |
| Example 2 | | | | | | (Occurred in large | |
| | | | | | | quantities of ball | |
| | | | | | | lift defects) | |
| Example 1 | 10 | 58 | 10 | AVG12.80 | AVG8.15 | 0 | AVG1500k |
| Example 2 | 10 | 75 | 10 | AVG12.85 | AVG7.90 | 0 | AVG1000k |
| Example 3 | 10 | 60 | 10 | AVG13.50 | AVG7.88 | 0 | AVG1200k |
| Example 4 | 10 | 80 | 10 | AVG11.43 | AVG7.93 | 0 | AVG1200k |

From Table 1, the capillary of Comparative Example 1 is a conventional capillary and shows normal conditions in the values of the wire bonding variables and the values of tensile strength and shear strength, but it shows a problem of almost 100% occurrence of contact with an adjacent wire by the capillary. To improve this, in the case of Example 2 in which the height of the bottleneck was increased from 0.15 mm to 0.3 mm, the problem of contact with the adjacent wire by the capillary was solved, but as shown in Table 1, the values of the bonding variables increased rapidly to make it difficult to carry out the bonding process, and because the values of wire tensile strength and wire shear strength are decreased markedly after carrying out bonding, defects of ball lift occurred in large quantities.

In contrast to this, in Examples 1 through 4 relating to the capillary of the present invention, the values of the bonding variables showed normal conditions, and in Examples 1 and 3, the value of force is the same while the value of ultrasonic power added to the capillary is markedly decreased, so that it is possible to prolong the lifetime of the capillary use as well as prevent ball lift defects from occurring due to application of excessive ultrasonic power, as in Comparative Example 2. Also, as shown in Table 1, in Examples 1 through 4, sufficient height is secured by the second bottleneck portion so as to prevent fundamentally contact between the wire and the capillary that deforms adjacent wires.

As described in the above, the present invention has the advantage of increasing the amplitude enlargement ratio of the ultrasonic power added to the capillary by providing a second bottleneck portion having a height of 1.5˜5.0 mm from the end of capillary, and a taper of 10˜15°. Furthermore, by providing an effect of sufficiently increasing the bottleneck height, it is possible to obtain the targeted tensile strength and shear strength of the bonding portion with low bonding force and low bonding power alone, and completely solve the problem of shape deformation of the bonded wire by preventing contact between the capillary and adjacent wires in the bonding process.

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

What is claimed is:

1. A two-step high bottleneck type capillary for a wire bonding device comprising:
a straight portion,
a first bottleneck portion extending upwards from the end of the capillary to a first step with a first taper of 8˜12°, said first bottleneck portion having a first height of 0.1˜0.5 mm from the end of the capillary to the first step, and a second bottleneck portion extending upwards from the first step to a second step on the border of the straight portion with a second taper of 10˜15°, said second bottleneck portion having a second height of 1.1˜5.0 mm from the end of the capillary to the second step.

2. The capillary according to claim 1, wherein said first bottleneck portion has a first height of 0.3 mm and a first taper of 10°, and said second bottleneck portion has a second height of 4.5 mm and a second taper of 15°.

3. The capillary according to claim 1, wherein said first bottleneck portion has a first height of 0.3 mm and a first taper of 10°, and said second bottleneck portion has a second height of 2.5 mm and a second taper of 15°.

4. The capillary according to claim 1, wherein said first bottleneck portion has a first height of 0.3 mm and a first taper of 10°, and said second bottleneck portion has a second height of 4.5 mm and a second taper of 12°.

5. The capillary according to claim 1, wherein said first bottleneck portion has a first height of 0.3 mm and a first taper of 10°, and said second bottleneck portion has a second height of 2.5 mm and a second taper of 12°.
